(19) United States
(12) Patent Application Publication
(10) Pub. No.: US 2005/0055591 A1
(43) Pub. Date: Mar. 10, 2005

(54) Computer system and a control method thereof

(75) Inventor: Kang-seok Cho, Yongin city (KR)

Correspondence Address: STAAS & HALSEY LLP, SUITE 700, 1201 NEW YORK AVENUE, N.W., WASHINGTON, DC, 20005, US

(73) Assignee: Samsung Electronic Co., Ltd., Suwon-si (KR)

(21) Appl. No.: 10/812,020

(22) Filed: Mar. 30, 2004

(30) Foreign Application Priority Data
Sep. 8, 2003 (KR) 2003-62685

(51) Int. Cl. G06F 1/32

(52) U.S. Cl. 713/320

(57) ABSTRACT

A computer system having a system memory; a power management controller to control to supply power to a system; a flash memory; and a controller to supply a power saving standby mode to enable the power saving standby mode and to control the power management controller to store an operating state stored in the system memory to the flash memory and to cut power supply to the system when the power saving standby mode is selected. The power saving standby mode using the flash memory is supplied in an operating system or in the BIOS of the system so that time to enter the standby mode or return to the normal mode is sharply reduced and power consumption to operate the standby mode is reduced. Further, a detachable flash memory is used in the normal state so that the operation state when the computer system enters the standby mode is separately stored and the operation state when the computer system enters the standby mode is started any time during the normal mode.

### CROSS-REFERENCE TO RELATED APPLICATIONS

This application claims the benefit of Korean Patent Application No. 2003-62685, filed on Sep. 8, 2003, in the Korean Intellectual Property Office, the disclosure of which is incorporated herein by reference.

### BACKGROUND OF THE INVENTION

1. Field of the Invention

The present invention relates to a computer system and a control method thereof, and more particularly, to a computer system according to which a time required to enter a standby mode and return to a normal mode and power consumption required during the standby mode is sharply reduced, and a control method thereof.

2. Description of the Related Art

In order to reduce power consumption of computers, a power management function according to which a display no longer displays a picture when data has not been input from an input device over a predetermined period of time and a hard disc drive that is not operated when there has been no access to the hard disc drive over a predetermined period of time has been implemented.

Recently, a power management function called advanced configuration and power interface specification (ACPI), which manages electric power of a system by classifying status of a computer system into five states has been developed and used.

According to the ACPI, the power management states of the computer system are classified into 6 sleeping states of S0 through S5. Accordingly, S0 is a regular state, states S1 through S4 are states in which electric power is gradually reduced, and state S5 is a soft-off state in which all of power of the system is cut. A power supply of the computer system having the above power management system supplies the ATX standard according to which a power supply system is divided into main power and standby power. The power supply supporting the ATX standard usually outputs the standby power when external power is supplied, and the standby power is supplied to a power management controller of the computer system.

The state S3 in the ACPI reoperates the computer system quickly. According to this state, power is not supplied to other hardware devices with the exception of a system memory comprising nonvolatile memory and the power management controller. The process in which the system enters S3 is referred to as ‘suspend to RAM’. In this operation, operating state data are stored in the system memory and ACPI S3 is stored in the power management controller.

When the computer system is switched from state S3 to a normal state, the computer does not go through a normal booting process so that the system can be operated quickly.

However, because the system memory is a volatile memory, the standby power needs to be continually supplied to save operating state data stored in the system memory, and thereby presents a problem as electric power continues to be consumed. This problem may be serious, especially for a portable computer using battery, which usually has only limited power supply.

### SUMMARY OF THE INVENTION

Accordingly, it is an aspect of the present invention to provide a computer system according to which a time required to enter a standby mode and return to a normal mode and power consumption required during the standby mode is sharply reduced, and a control method thereof.

The foregoing and/or other aspects of the present invention are achieved by providing a method to control a computer system having a system memory and a power management controller to control supply power to the system. The method comprises: selecting a power saving standby mode; storing an operating state stored in the system memory to a flash memory, when the power saving standby mode is selected; and cutting power supply to the system.

Additional aspects and advantages of the invention will be set forth in part in the description which follows and, in part, will be obvious from the description, or may be learned by practice of the invention.

According to another aspect of the invention, the control method of the computer further comprises: re-supplying power to the system when the power saving standby mode is changed to a normal mode in which normal operations are conducted; and storing the operating state stored to the flash memory in the system memory.

According to an aspect of the invention, the power saving standby mode is selected via a user interface.

According to another aspect of the invention, the selection of a power saving standby mode comprises: selecting a standby mode or a maximum power saving mode; checking whether the flash memory is connected; and determining the selection of the standby mode or the maximum power saving mode as the selection of the power saving standby mode when the flash memory is connected.

The foregoing and/or other aspects of the present invention are also achieved by providing a computer system comprising: a system memory; a power management controller to control supply power to the system; a flash memory; and a controller to supply a power saving standby mode to enable the power saving standby mode and to control the power management controller to store an operating state stored in the system memory to the flash memory, and to cut power supply to the system when the power saving standby mode is selected.

According to an aspect of the invention, the flash memory is connected to a universal serial bus (USB) port.

According to an aspect of the invention, the controller is provided in a basic input/output system (BIOS) of the system.

According to another aspect of the invention, the controller stores the operating state stored in the flash memory to the system memory when the power saving standby mode is changed to a normal mode in which normal operations are conducted.

### BRIEF DESCRIPTION OF THE DRAWINGS

The above and/or other aspects and advantages of the invention will become apparent, and more readily appreciated from the following description of the preferred embodiments, taken in conjunction with the accompanying drawings of which:

FIG. 1 is a control block diagram of a computer system according to an aspect of the present invention; and

FIGS. 2 and 3 are flow charts to show a control operation in a power saving standby mode of a computer system according to an aspect of the present invention.

### DETAILED DESCRIPTION OF THE PREFERRED EMBODIMENTS

Reference will now be made in detail to the embodiments of the present invention, examples of which are illustrated in the accompanying drawings, wherein like reference numerals refer to like elements throughout.

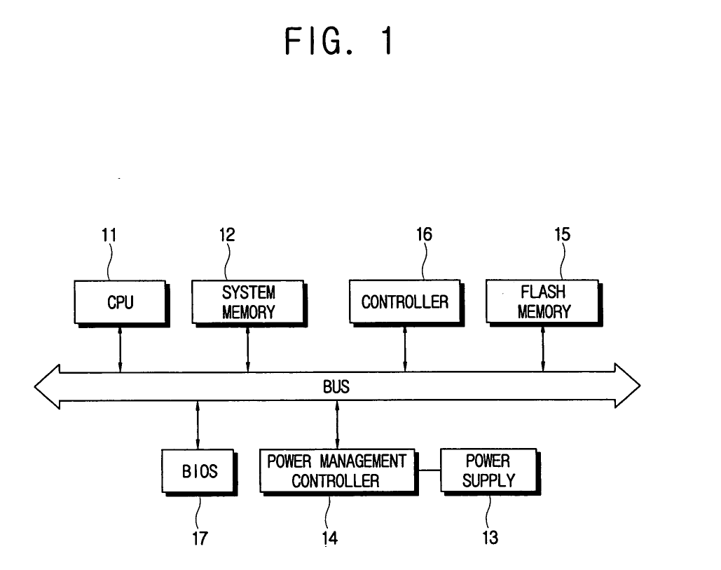

FIG. 1 is a control block diagram of a computer system according to an aspect of the present invention. As shown, the computer system that controls a power saving standby mode comprises: a central processing unit (CPU) 11 to conduct operations, a system memory 12 to store a present operating state, and a power management controller 14 to control a power supply 13 that supplies power to the system. The computer system further comprises: a flash memory 15 and a controller 16 to supply a power saving standby mode to enable the power saving standby mode and to control the power management controller 14 to store an operating state stored in the system memory 12 to the flash memory 15, and to cut electric power to the system when the power saving standby mode is selected.

The computer system commonly comprises: peripheral devices (not shown) such as a hard disk, a keyboard, a mouse, and other similar devices, and a basic input/output system (BIOS) 17 to control data flow between the computer and the operating system.

The flash memory 15 stores duplicate data in relation to the present operating state that is stored in the system memory 12.

Unlike D-RAM (dynamic random access memory), the flash memory is a non-volatile memory so that data stored in the memory is not lost even when electric power is no longer supplied. Further, because data is easily input to and output from the flash memory, flash memory is generally used for digital televisions, digital camcorders, mobile phones, digital cameras, MP3 players and other similar devices.

According to an aspect of the present invention, the flash memory 15 used in the computer system may be fixed on the main board provided inside of the computer system or detachably mounted on the main board. According to an aspect of the present invention, the USB (universal serial bus) flash memory coming into the market is used as the flash memory 15, because the USB flash memory having the capacity to store several giga bites of data has advantages of the USB including a high transmission speed and complete support of the plug and play function.

Thus, the USB flash memory enables to separately store the present operating state. Moreover, the USB flash memory allows an operation in a previous operating state to start only by connecting the flash memory 15 to the USB port and making a copy of data stored in the flash memory 14 to the system memory 12 when the computer is being operated in a normal mode.

The controller 16 supplies the power saving standby mode to allow the power saving standby mode to be selected and controls the power management controller 14 to store the operating state stored in the system memory 12 to the flash memory 15, and to cut power supply to the system when the power saving standby mode is selected.

To enable the power saving standby mode and to allow selection of the power saving standby mode, according to an aspect of the present invention, an item of the power saving standby mode is added to a power management set-up window in the operating system of a window based program. Otherwise, a power saving standby mode time set-up window is preferably provided to set up a predetermined time to enter the power saving standby mode.

When the power saving standby mode is selected, i.e., the item of the power saving standby mode is selected in the power management set-up window or the predetermined time to set up the power saving standby mode is completed, the controller 16 stores data in relation to the present operating state stored in the system memory 12 to the flash memory 15.

According to an aspect of the present invention, the operation of storing the data in the flash memory 15 is conducted in the operating system or in the BIOS 17.

When an operating system doesn't have the window via which the power saving standby mode is enabled, the operation of storing of data to the flash memory 15 is conducted in the BIOS 17.

Accordingly, when a standby mode or a maximum power saving mode is selected, it is checked whether the flash memory 15 is mounted. Upon determining that the flash memory 15 is mounted, the present operating state is stored to the flash memory 15. However, upon determining that the flash memory 15 is not mounted, the standby mode or the maximum power saving mode is determined to be selected.

The controller 16 controls the power management controller 14 to cut power supply to the system after the present operating state data is completely stored in the flash memory 15.

For example, when the power saving standby mode is selected, the controller 16 records a predetermined flag at a specific position in the power management controller 14 so that the power management controller 14 recognizes that the power saving standby mode is selected. Then, the power management controller 14 recognizing that the power saving standby mode is selected, controls the power supply 13 to cut power to the system based on the flag.

The control of the power management controller 14 may be conducted in the BIOS 17. The BIOS 17 stores the flag in the power management controller 14 and cuts power supply to the system after the present operating state is completely stored in the flash memory 15, for example, after receiving a power saving standby mode changing signal generated when the storage of data in the flash memory 15 is conducted in the operating system or after completely storing data when the storage of data in the flash memory 15 is conducted in the BIOS 17.

When the power saving standby mode is changed to the normal mode in which normal power is supplied to conduct operations, i.e., a normal mode changing signal is generated by an operation of a power button or a user's operation such as input of key provided in the system, the power is supplied to the system again and the controller 16 stores the operating state data stored in the flash memory 15 in the system memory 12.

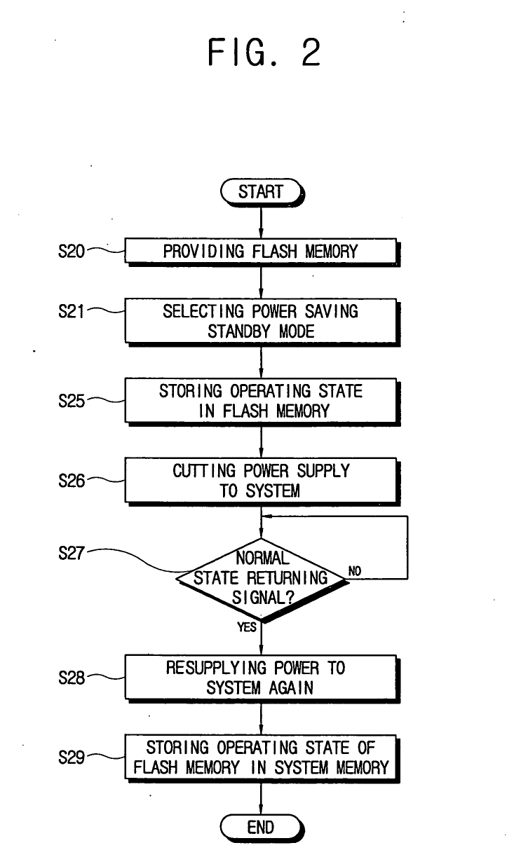

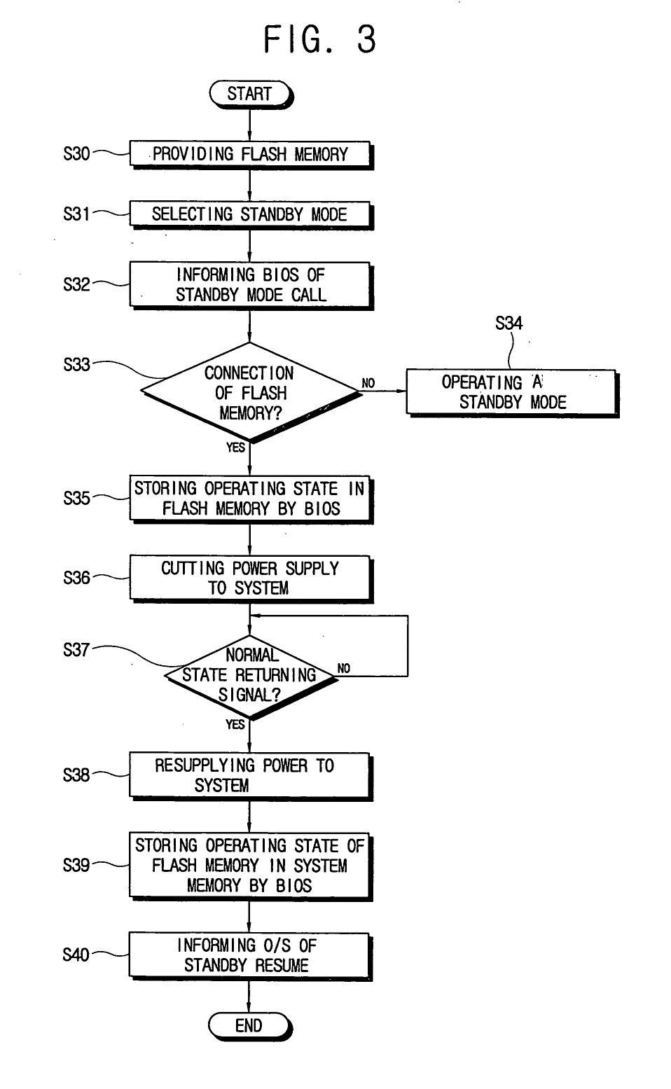

FIGS. 2 and 3 are flow charts to show a method to control the computer system in the power saving standby mode according to an aspect of the present invention. FIGS. 2 and 3 show control flows when the storage of data in the flash memory 15 is conducted in the operating system and in the BIOS 17, respectively.

First, the flash memory 15 is provided at operation S20, as shown in FIG. 2. The flash memory 15 may be provided before the system is booted or any time in the normal state after the system is booted.

When a user selects the power saving standby mode through a window via a user interface provided by the operating system at operation S21 when the system is operated in the normal state, the operating system stores the present operating state data stored in the system memory 12 to the flash memory 15 at operation S25 and controls the power management controller 14 to make the BIOS 17 provided in the system including the power supply 13 to cut power to the system at operation S26.

Thus, the operating system supplies the power saving standby mode using the flash memory so that the user can directly select the power saving standby mode, which causes the time required to enter the standby mode and power consumption to operate the standby mode to be sharply reduced.

Further, the detachable flash memory is also used during the normal state so that the operation state when the computer system enters the standby mode is separately stored and the operation state when the computer system enters the standby mode can be started any time in the normal mode.

When the normal mode returning signal is transmitted to cause the system to change from the power saving standby mode to the normal mode at operation S27, the BIOS 17 re-supplies power to the system by using the power supply 13 and the power management controller 14 at operation S28, which is similar to when the standby mode or the maximum power saving mode is changed to the normal mode. Here, the normal mode changing signal is generally generated by a user's operation such as pushing the power button provided in the system.

When power is resupplied to the system, the operating system stores the operating state stored in the flash memory 15 to the system memory 12 at operation S29 and returns to the normal mode in which operations are conducted by restoring just the operating state stored in the system memory 12.

Thus, the power saving standby mode that doesn't include a booting process can be changed to the normal mode, thus, the resume time required to return to the normal mode is sharply reduced.

Further, the detachable flash memory is also used during the normal state so that the operation state when the computer system enters the standby mode can be started any time in the normal mode.

As shown in FIG. 3, the computer system is controlled as follows when the storage of data in the flash memory 15 is conducted in the BIOS 17. First, the flash memory is provided at operation S30. Here, the flash memory 15 may be provided before the system is booted or any time during the normal state after the system is booted.

When the user selects the standby mode (or the maximum power saving mode) by using a window via a user interface provided by the operating system when the system is operated in the normal mode at operation S31, the operating system informs the BIOS 17 that the standby mode (or the maximum power saving mode) is selected at operation S32.

After informing that the standby mode (or the maximum power saving mode) is selected, the BIOS 17 checks whether the flash memory 15 is connected to the system at operation S33. Upon determining that the flash memory 15 is not connected to the system, the BIOS 17 conducts the procedure when the standby mode (or the maximum power saving mode) is selected in the computer system at operation S34.

On the other hand, upon determining that the flash memory 15 is connected to the system, the BIOS 17 stores the present operating state data stored in the system memory 12 to the flash memory 15 at operation S35 and cuts power supply to the system at operation S36.

As shown in FIG. 3, operations S31 through S33 and the operation of determining that the flash memory 15 is connected to the system correspond to the selection of the power saving standby mode of S21 in FIG. 2.

Thus, the standby mode (or the maximum power saving mode) is supplied in the BIOS using the flash memory so that the time to enter the standby mode and power consumption to operate the standby mode is sharply reduced although the user cannot directly select the power saving standby mode.

When the normal mode changing signal to change the standby mode to the normal mode is transmitted at operation S37, the BIOS 17 re-supplies electric power to the system at operation S38 and stores the operating state stored in the flash memory 15 to the system memory 12 at operation S39. Further, the BIOS 17 revives the normal mode in which the operating state stored in the system memory 12 is restored, operations are conducted in the above operating state, and informs the operating system that the computer system has changed from the standby mode to the normal mode at operation S40.

Thus, the standby mode (or the maximum power saving mode) that doesn't include a booting process is changed to the normal mode, and the resume time required to return to the normal mode is sharply reduced.

Further, the detachable flash memory is also used in the normal state so that the operation state when the computer system enters the standby mode is separately stored, and the operation state when the computer system enters the standby mode is started any time in the normal mode.

According to the above configuration, the power saving standby mode using the flash memory is supplied in the operating system or in the BIOS so that the time to enter the standby mode or return to the normal mode is sharply reduced and power consumption to operate the standby mode is reduced.

Further, the detachable flash memory is also used in the normal state so that the operation state when the computer system enters the standby mode is separately stored, and the operation state when the computer system enters the standby mode is started any time in the normal mode.

Although a few embodiments of the present invention have been shown and described, it will be appreciated by those skilled in the art that changes may be made in these embodiments without departing from the principles and spirit of the invention, the scope of which is defined in the appended claims and their equivalents.

1. A computer system, comprising:
a system memory;
a power management controller to control a supply power to the system;
a flash memory; and
a controller to enable a power saving standby mode, to control the power management controller to store an operating state stored in the system memory to the flash memory, and to cut power supply to the system when the power saving standby mode is selected.

2. The computer system according to claim 1, wherein the flash memory is connected to a universal serial bus port.

3. The computer system according to claim 1, wherein the controller is provided in a basic input/output system of the system.

4. The computer system according to claim 1, wherein the controller stores the operating state stored in the flash memory to the system memory when the power saving standby mode is changed to a normal mode in which normal operations are conducted.

5. The computer system according to claim 4, wherein the controller is provided in a basic input/output system of the system.

6. A control method of a computer system having a system memory and a power management controller to control a supply power to the system, comprising:
selecting a power saving standby mode;
storing an operating state stored in the system memory to a flash memory when the power saving standby mode is selected; and
cutting power supply to the system after the operating state has been stored.

7. The control method of the computer system according to claim 6, further comprising:
re-supplying power to the system when the power saving standby mode is changed to a normal mode in which normal operations are conducted; and
storing the operating state stored in the flash memory to the system memory.

8. The control method of the computer system according to claim 6, wherein the power saving standby mode is selected via a user interface.

9. The control method of the computer system according to claim 6, wherein the selection of the power saving standby mode comprises:
selecting a standby mode or a maximum power saving mode;
checking whether the flash memory is enabled; and
determining the selection of the standby mode or the maximum power saving mode as the selection of the power saving standby mode when the flash memory is connected.

10. The computer system according to claim 1, wherein the flash memory is detachably provided to the computer system.

11. The computer system according to claim 1, further comprising:
an operating system having a power management setup window via which the power saving standby mode is enabled.

12. The computer system according to claim 1, wherein a predetermined time is set to enter the power saving standby mode.

13. The computer system according to claim 2, wherein the controller controls the power management controller to copy the operating state stored in the flash memory to the system memory via the universal serial bus port when the power saving mode is changed to a normal mode.

14. A computer system having a system memory, comprising:
a power management controller to control a supply power to the computer system;
a flash memory; and
a controller to control the power management controller to store-an operating state data stored in the system memory to the flash memory when a power saving standby mode is selected, to cut the power supply to the system, and to store the operating state to the system memory when a normal mode is selected.

15. The computer system according to 14, further comprising:
an operating system having a power management setup window via which the power saving standby mode is enabled.

16. The computer system according to claim 14, wherein the flash memory is connected to a universal serial bus port, and the operating state data is accessible when the flash memory is connected to the universal serial bus port.

17. The computer system according to claim 14, wherein storing of the operating state to the flash memory is performed in a basic input/output system of the computer system.

18. A method of control a computer system having a system memory and a power management controller to control a supply power to the system, comprising:
copying an operating state data stored in the system memory to a flash memory when a power saving standby mode of the computer system is activated; and
copying the operating state data back to the system memory when a normal mode of the computer system is activated.

19. The method according to claim 18, wherein the normal mode of the computer system is activated without a booting process.
